(19) United States
(12) Patent Application Publication
(10) Pub. No.: US 2024/0260664 A1
(43) Pub. Date: Aug. 8, 2024

(54) AEROSOL GENERATION SYSTEM

(71) Applicant: Japan Tobacco Inc., Tokyo (JP)

(72) Inventors: Yasunobu INOUE, Tokyo (JP); Ryoji FUJITA, Tokyo (JP); Sumie MIKAMI, Tokyo (JP); Kazutoshi SERITA, Tokyo (JP)

(73) Assignee: Japan Tobacco Inc., Tokyo (JP)

(21) Appl. No.: 18/639,966

(22) Filed: Apr. 19, 2024

Related U.S. Application Data
(63) Continuation of application No. PCT/JP2021/045027, filed on Dec. 8, 2021.

(51) Int. Cl. A24F 40/46; A24F 40/20; A24F 40/51

(52) U.S. Cl. CPC A24F 40/46; A24F 40/20; A24F 40/51

(57) ABSTRACT

This aerosol generation system including a resistive heating unit that heats an aerosol generating base material from the inside thereof; and a pair of metal plates provided on mutually opposing surfaces of the resistive heating unit, wherein the pair of metal plates include a first region where the metal plates face each other with the resistive heating unit interposed therebetween in the thickness direction of the resistive heating unit, and a second region where the metal plates do not face each other with the resistive heating unit interposed therebetween in the thickness direction of the resistive heating unit.

### CROSS-REFERENCE TO RELATED APPLICATION

This application is a Continuation of PCT International Application No. PCT/JP2021/045027, filed on Dec. 8, 2021, which is hereby expressly incorporated by reference into the present application.

### TECHNICAL FIELD

The present invention relates to aerosol generation systems.

### BACKGROUND ART

Inhaler devices including electronic cigarettes and nebulizers that generate material to be inhaled by users are becoming widely popular. Such an inhaler device uses an aerosol source for generating an aerosol and a flavor source for imparting a flavor component to the generated aerosol, so as to be capable of generating a flavor-component-imparted aerosol. A user can taste the flavor by inhaling the flavor-component-imparted aerosol generated by the inhaler device.

In recent years, technology related to an inhaler device of a type that uses a stick-shaped substrate as an aerosol source or a flavor source is being actively developed. For example, Patent Literature 1 indicated below discloses a blade-shaped heater that is inserted into the stick-shaped substrate to heat the substrate from the inside thereof.

### CITATION LIST

### Patent Literature

Patent Literature 1: CN 209807157 U

### SUMMARY OF INVENTION

### Technical Problem

However, with regard to the heater disclosed in Patent Literature 1 indicated above, since the entire heater produces heat uniformly, the heat produced from the heater may possibly be transmitted to areas other than the aerosol generating substrate. Therefore, the heating efficiency for the aerosol generating substrate may possibly decrease, and the heat produced from the heater may possibly have an effect on the reliability of the inhaler device.

The present invention has been made in view of the above problem, and an object of the present invention is to provide a new and improved aerosol generation system that can suppress transmission of heat produced from the heater to areas other than the aerosol generating substrate.

### Solution to Problem

In order to solve the above problem, an aspect of the present invention provides an aerosol generation system including: a resistive heat generator that heats an aerosol generating substrate from an inside thereof; and a pair of metal plates provided at opposite surfaces of the resistive heat generator. The pair of metal plates each include a first region and a second region. The first region is where the metal plates face each other with the resistive heat generator interposed therebetween in a thickness direction of the resistive heat generator. The second region is where the metal plates do not face each other with the resistive heat generator interposed therebetween in the thickness direction of the resistive heat generator.

The first regions may be provided toward a leading end of the resistive heat generator to be inserted into the aerosol generating substrate, and the second regions may be provided toward a trailing end opposite the leading end.

The second regions may be provided as partial cut-outs of the metal plates such that the metal plates do not face each other with the resistive heat generator interposed therebetween in the thickness direction of the resistive heat generator.

The pair of metal plates in the second regions may be partially cut out such that edges of the metal plates remain, the edges being located diagonally from each other in a cross-sectional shape of the resistive heat generator.

The metal plates cut out in the second regions may have a rectangular shape.

A securing section having an insertion section into which the metal plates and the resistive heat generator are inserted may be further provided. The securing section secures the metal plates and the resistive heat generator to a housing.

The metal plates in the second regions and the resistive heat generator may be inserted into the insertion section.

The securing section may be composed of a super engineering plastic material.

The securing section may have a circular or rectangular tabular shape.

Each of the metal plates may be composed of a nickel-containing iron alloy.

The resistive heat generator may have a tabular shape.

A thickness of the tabular shape may be smaller than ¼ of a width of the tabular shape.

The aerosol generating substrate into which the resistive heat generator and the metal plates are inserted may be further provided.

At least one of the metal plates may include a rib formed by bending an edge of the metal plate along an outer shape of the resistive heat generator from the opposite surfaces of the resistive heat generator.

The resistive heat generator may have an angularly protruding shape toward a leading end to be inserted into the aerosol generating substrate.

At least one of the metal plates may further include a leading-end rib formed by bending an edge of the metal plate along the shape at the leading end of the resistive heat generator.

The resistive heat generator and the metal plates may be adhered together by using a conductive adhesive paste.

The resistive heat generator may be a PTC heater.

The resistive heat generator may contain barium titanate.

A temperature of heat generated by the resistive heat generator may be below 350° C.

### Advantageous Effects of Invention

According to the present invention described above, transmission of heat produced from the heater to areas other than the aerosol generating substrate can be suppressed.

### BRIEF DESCRIPTION OF DRAWINGS

FIG. 1 is a schematic diagram schematically illustrating a configuration example of an inhaler device according to an embodiment of the present invention.

FIG. 2 is an exploded perspective view of a heater body included in the heater.

FIG. 3 is a perspective view of the heater including the heater body illustrated in FIG. 2.

FIG. 4 is an exploded perspective view of a heater body according to a first modification.

FIG. 5 is an exploded perspective view of a heater body according to a second modification.

FIG. 6 is an exploded perspective view of a heater body according to a third modification.

FIG. 7 is an exploded perspective view of a heater body according to a fourth modification.

### DESCRIPTION OF EMBODIMENTS

A preferred embodiment of the present invention will be described in detail below with reference to the appended drawings. In this description and the drawings, structural elements having substantially identical functional configurations will be given the same reference signs, and redundant descriptions thereof will be omitted.

### 1. Configuration Example of Inhaler Device

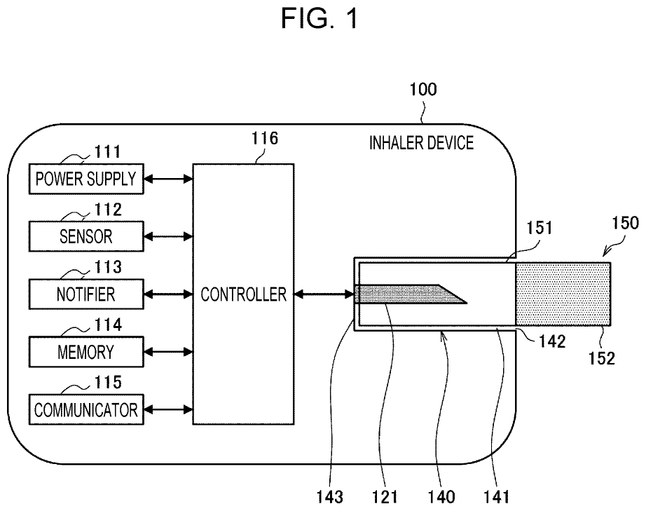

An inhaler device according to a present configuration example generates an aerosol by heating a substrate containing an aerosol source from inside the substrate. The present configuration example will be described below with reference to FIG. 1.

FIG. 1 is a schematic diagram schematically illustrating the configuration example of the inhaler device. As illustrated in FIG. 1, an inhaler device 100 according to this configuration example includes a power supply 111, a sensor 112, a notifier 113, a memory 114, a communicator 115, a controller 116, a heater 121, and a container 140. With regard to the inhaler device 100, inhalation is performed by a user in a state where a stick substrate 150 is accommodated in the container 140. The structural elements will be sequentially described below.

The inhaler device 100 and the stick substrate 150 operate in cooperation with each other to generate the aerosol to be inhaled by the user. Therefore, the combination of the inhaler device 100 and the stick substrate 150 may be regarded as an aerosol generation system.

The power supply 111 stores electric power. The power supply 111 supplies the electric power to the structural elements of the inhaler device 100. For example, the power supply 111 may be a rechargeable battery, such as a lithium ion secondary battery. The power supply 111 may be recharged by being connected to an external power supply by, for example, a USB (universal serial bus) cable. Alternatively, the power supply 111 may be recharged in a non-connected state with a power-transmitting device by wireless power transmission technology. As another alternative, the power supply 111 may be removable from the inhaler device 100 so as to be replaceable with a new power supply 111.

The sensor 112 detects various types of information regarding the inhaler device 100, and outputs the detected information to the controller 116. In an example, the sensor 112 may be a pressure sensor such as a microphone condenser, a flow sensor, or a temperature sensor. When detecting a numerical value generated in accordance with the user's inhalation, the pressure sensor, the flow sensor, or the temperature sensor can output information indicating that the inhalation has been performed by the user to the controller 116. In another example, the sensor 112 may be an input device, such as a button or a switch, receiving information input by the user. In particular, the sensor 112 may include a command button for starting/stopping aerosol generation. The input device that receives information input by the user can output the information input by the user to the controller 116. In another example, the sensor 112 may be a temperature sensor that detects the temperature of the heater 121. For example, by detecting the temperature of the heater 121 based on an electrical resistance value of the heater 121, the temperature sensor can determine the temperature of the stick substrate 150 accommodated in the container 140.

The notifier 113 notifies the user of information. In an example, the notifier 113 is a light-emitting device, such as an LED (light-emitting diode). Accordingly, when the power supply 111 needs to be recharged, when the power supply 111 is being recharged, or when an abnormality has occurred in the inhaler device 100, the notifier 113 can emit light in different patterns of light, respectively. Each pattern of light is a concept involving colors and on/off timings. Together with or in place of the light-emitting device, the notifier 113 may be, for example, a display device that displays an image, a sound output device that outputs sound, and a vibration device that vibrates. The notifier 113 may also provide notification information indicating that inhalation by the user is possible. The notification information indicating that inhalation by the user is possible may be provided when the temperature of the stick substrate 150 heated by the heater 121 reaches a predetermined temperature.

The memory 114 stores various types of information for operation of the inhaler device 100. The memory 114 is, for example, a non-volatile storage medium, such as a flash memory. An example of the information stored in the memory 114 is information regarding the OS (operating system) of the inhaler device 100, such as the control information about the various types of structural elements controlled by the controller 116. Another example of the information stored in the memory 114 is information regarding inhalation by the user, such as the number of times of inhalation, the inhalation time, and the accumulated inhalation time period.

The communicator 115 is a communication interface for exchanging information between the inhaler device 100 and another device. The communicator 115 performs communication in conformity with any wired or wireless communication standard. Such a communication standard may be, for example, a wireless LAN (local area network), a wired LAN, Wi-Fi (registered trademark), or Bluetooth (registered trademark). In an example, the communicator 115 may transmit the information regarding the inhalation by the user to a smartphone to cause the smartphone to display the information regarding the inhalation by the user. In another example, the communicator 115 may receive information about a new OS from a server to update the information about the OS stored in the memory 114.

The controller 116 functions as an arithmetic processing unit and a control device, and controls the overall operation in the inhaler device 100 in accordance with various programs. For example, the controller 116 is implemented by an electronic circuit, such as a CPU (central processing unit) or a microprocessor. Furthermore, the controller 116 may include a ROM (read only memory) that stores a program and arithmetic parameter to be used, and a RAM (random access memory) that temporarily stores an appropriately changing parameter. The inhaler device 100 executes various processes based on control by the controller 116. Examples of the processes controlled by the controller 116 include supplying of electric power from the power supply 111 to the other structural elements, recharging of the power supply 111, detection of information by the sensor 112, notification of information by the notifier 113, storing and reading of information by the memory 114, and exchanging of information by the communicator 115. Other processes executed by the inhaler device 100, such as an input of information to each structural element and a process based on information output from each structural element, are also controlled by the controller 116.

The container 140 has an internal space 141 and holds the stick substrate 150 while accommodating a portion of the stick substrate 150 within the internal space 141. The container 140 has an opening 142 through which the internal space 141 communicates with the outside, and holds the stick substrate 150 inserted in the internal space 141 through the opening 142. For example, the container 140 is a tubular body having the opening 142 and a bottom 143 as a bottom surface, and defines the internal space 141 that is pillar-shaped. The container 140 has an inside diameter smaller than an outside diameter of the stick substrate 150 in at least a portion of the tubular body in the height direction, and may hold the stick substrate 150 while applying pressure around the stick substrate 150 inserted in the internal space 141. The container 140 also has a function for defining a flow path for air traveling through the stick substrate 150. An air inlet serving as an inlet for the air entering the flow path is disposed in, for example, the bottom 143. On the other hand, an air outlet serving as an outlet for the air exiting from the flow path is the opening 142.

The stick substrate 150 is a stick-shaped aerosol generating substrate. The stick substrate 150 includes a substrate 151 and an inhalation port 152.

The substrate 151 contains an aerosol source. The aerosol source atomizes by being heated, so that an aerosol is generated. The aerosol source may include, for example, a material derived from tobacco, such as a product obtained by forming shredded tobacco or tobacco raw material into a granular form, a sheet form, or a powder form. The aerosol source may also include a material not derived from tobacco and made from a plant (such as mint or herb) other than tobacco. If the inhaler device 100 is a medical inhaler, the aerosol source may include a medicine to be inhaled by a patient. The aerosol source is not limited to a solid and may be a liquid, such as polyhydric alcohol, including glycerine or propylene glycol, or water. At least a portion of the substrate 151 is accommodated in the internal space 141 of the container 140 in the state where the stick substrate 150 is held by the container 140.

The inhalation port 152 is a member to be held in the user's mouth during inhalation. At least a portion of the inhalation port 152 protrudes from the opening 142 in the state where the stick substrate 150 is held by the container 140. When the user holds the inhalation port 152 protruding from the opening 142 in the user's mouth and inhales, air flows into the container 140 through the air inlet (not illustrated). The air flowing in travels through the internal space 141 of the container 140, that is, through the substrate 151, and reaches the inside of the user's mouth together with the aerosol generated from the substrate 151.

The heater 121 heats the aerosol source so as to atomize the aerosol source and generate the aerosol. As will be described in detail later, the heater 121 is blade-shaped and is disposed to protrude from the bottom 143 of the container 140 to the internal space 141 of the container 140. Therefore, when the stick substrate 150 is inserted into the container 140, the blade-shaped heater 121 is inserted into the stick substrate 150 to pierce the substrate 151 of the stick substrate 150. When the heater 121 produces heat, the aerosol source contained in the stick substrate 150 atomizes by being heated from inside the stick substrate 150, whereby the aerosol is generated. The heater 121 produces heat when supplied with electric power from the power supply 111. In an example, when the sensor 112 detects that a predetermined user input has been performed, the heater 121 supplied with the electric power produces heat. When the temperature of the stick substrate 150 reaches the predetermined temperature, the aerosol is generated from the stick substrate 150. Accordingly, the inhaler device 100 allows for inhalation by the user. Subsequently, when the sensor 112 detects that a predetermined user input has been performed, the supply of electric power to the heater 121 may be stopped. In another example, in a time period in which the sensor 112 detects that the inhalation has been performed by the user, the aerosol may be generated by the heater 121 supplied with the electric power.

### 2. Detailed Configuration of Heater

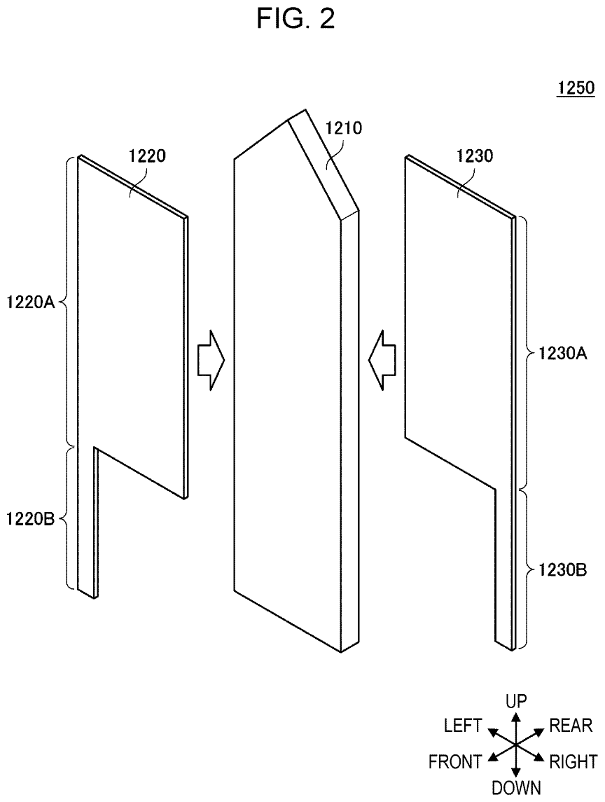

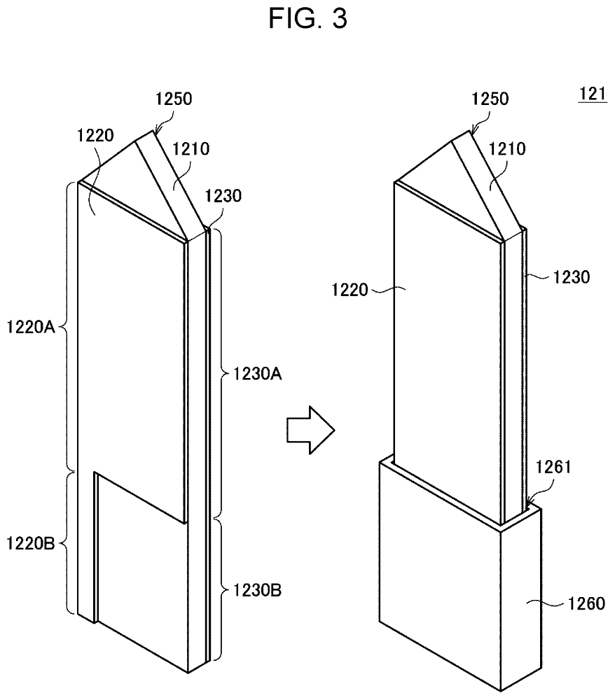

Next, the heater 121 included in the inhaler device 100 according to this embodiment will be described in further detail with reference to FIG. 2 and FIG. 3. FIG. 2 is an exploded perspective view of a heater body 1250 included in the heater 121. FIG. 3 is a perspective view of the heater 121 including the heater body 1250 illustrated in FIG. 2.

As illustrated in FIG. 2, the heater body 1250 includes a resistive heat generator 1210, a first metal plate 1220, and a second metal plate 1230. The heater body 1250 can heat the stick substrate 150 from the inside thereof by using heat generated from the resistive heat generator 1210 supplied with electricity via the first metal plate 1220 and the second metal plate 1230.

As illustrated in FIG. 3, the heater body 1250 in which the resistive heat generator 1210, the first metal plate 1220, and the second metal plate 1230 are bonded together is secured to, for example, a housing of the inhaler device 100 by being held by a securing section 1260. Specifically, for example, the heater 121 is constituted of the heater body 1250 and the securing section 1260.

In FIG. 2 and FIG. 3, a direction in which the leading end of the heater body 1250 is inserted into the stick substrate 150 may also be referred to as “up direction”, and a direction opposite the up direction may also be referred to as “down direction”. A direction in which the first metal plate 1220, the resistive heat generator 1210, and the second metal plate 1230 are bonded together may also be referred to as “front-rear direction”, and a direction orthogonal to the up-down direction and the front-rear direction may also be referred to as “left-right direction”.

The resistive heat generator 1210 is a tabular member that generates heat by resistance heating. In detail, the resistive heat generator 1210 may be a PTC (positive temperature coefficient) heater that generates heat when electricity is supplied between the first metal plate 1220 and the second metal plate 1230.

A PTC heater uses a resistor having properties (PTC properties) in which an electrical resistance value increases significantly when the temperature reaches a predetermined temperature (referred to as “Curie temperature”) such that an electric current does not flow therethrough. By utilizing the PTC properties, a PTC heater can control the amount of supplied electricity without having to use a control device, so as to be capable of controlling the heating temperature below the Curie temperature. Therefore, a PTC heater can heat a target below the

Curie temperature. For example, the resistive heat generator 1210 may be a PTC heater with barium titanate (BaTiO₃) having the PTC properties as the resistor. In such a case, the resistive heat generator 1210 can set the Curie temperature of the barium titanate to 350° C., so as to be capable of heating the stick substrate 150 to a temperature below 350° C.

Each property, such as the Curie temperature of the barium titanate having the PTC properties or the electrical resistance value, can be controlled by using, for example, an additive added in a very small quantity to the barium titanate. In detail, for example, an alkaline-earth metal element, such as calcium (Ca) or strontium (Sr), or a rare-earth metal element, such as yttrium (Y), neodymium (Nd), samarium (Sm), or dysprosium (Dy), may be added to the barium titanate. The added element replaces the Ba site or the Ti site of the barium titanate, so that the structure of the sintered body of the barium titanate can be controlled. With the structure of the sintered body being controlled, each property, such as the Curie temperature or the electrical resistance value, of the barium titanate can be controlled.

The resistive heat generator 1210 may have a long tabular shape extending in the up-down direction. Specifically, the longitudinal direction of the long shape of the resistive heat generator 1210 corresponds to the up-down direction, whereas the lateral direction of the long shape corresponds to the left-right direction. By having a long tabular shape, the resistive heat generator 1210 has a rectangular cross-sectional shape that is orthogonal to the longitudinal direction (i.e., the up-down direction) of the long shape. Accordingly, as compared with a case where the resistive heat generator 1210 has a circular cross-sectional shape with the same surface area, the cross-sectional shape can have a longer perimeter. Therefore, the resistive heat generator 1210 can allow for a larger contact area between the heater 121 and the stick substrate 150 to which the heater 121 is to be inserted, whereby the stick substrate 150 can be heated more efficiently. For example, the tabular shape of the resistive heat generator 1210 may have a thickness smaller than ¼ of the width of the long shape in the lateral direction (i.e., the left-right direction).

The resistive heat generator 1210 at the leading end to be inserted into the stick substrate 150 may have an angularly protruding shape toward the leading end (i.e., in the up direction). The angular shape extending toward the leading end may have an acute angle, a right angle, or an obtuse angle. For example, the resistive heat generator 1210 may have a pentagonal tabular shape whose apex exists at the leading end (i.e., the upper end) to be inserted into the stick substrate 150 and that extends in the up-down direction. With regard to the resistive heat generator 1210, the leading end (i.e., the upper end) thereof to be inserted into the stick substrate 150 has a pointy shape like a sword tip, so that the heater 121 can be inserted into the stick substrate 150 more readily.

The first metal plate 1220 and the second metal plate 1230 are a pair of electrode plates sandwiching the resistive heat generator 1210 therebetween. In detail, the first metal plate 1220 and the second metal plate 1230 may be provided at opposite principal surfaces opposing each other in the front-rear direction of the tabular resistive heat generator 1210. The first metal plate 1220 and the second metal plate 1230 are provided apart from each other to prevent a short-circuit.

The first metal plate 1220 and the second metal plate 1230 are bonded to the resistive heat generator 1210 by using a conductive adhesive paste, so that electricity can be supplied to the resistive heat generator 1210. An example of the conductive adhesive paste that can be used is a so-called anisotropic conductive adhesive having conductive particles uniformly distributed within an epoxy-based adhesive.

In an example, the first metal plate 1220 and the second metal plate 1230 may be composed of metal with a low thermal expansion coefficient. For example, the first metal plate 1220 and the second metal plate 1230 may be composed of a nickel (Ni) containing iron alloy with a low thermal expansion coefficient, such as Invar (registered trademark). Accordingly, delamination of the first metal plate 1220 and the second metal plate 1230 from the resistive heat generator 1210 due to thermal expansion occurring when the resistive heat generator 1210 generates heat can be suppressed.

In the inhaler device 100 according to this embodiment, the first metal plate 1220 includes a first region 1220A and a second region 1220B that are arranged in the longitudinal direction. The second metal plate 1230 includes a first region 1230A and a second region 1230B that are arranged in the longitudinal direction.

The first regions 1220A and 1230A are provided toward the leading end (i.e., the upper side) of the heater body 1250 to be inserted into the stick substrate 150, and the second regions 1220B and 1230B are provided toward the trailing end (i.e., the lower side) opposite the leading end.

The first regions 1220A and 1230A are regions where the first metal plate 1220 and the second metal plate 1230 face each other with the resistive heat generator 1210 interposed therebetween in the thickness direction of the resistive heat generator 1210. In the first regions 1220A and 1230A, for example, the first metal plate 1220 and the second metal plate 1230 may be provided to have the same rectangular shape and cover the resistive heat generator 1210.

In the first regions 1220A and 1230A, the distance between the first metal plate 1220 and the second metal plate 1230 may be substantially equal to the thickness of the resistive heat generator 1210 in the front-rear direction. Therefore, in the first regions 1220A and 1230A, the distance between the first metal plate 1220 and the second metal plate 1230 is relatively short, so that the electrical resistance value between the first metal plate 1220 and the second metal plate 1230 is reduced, whereby a large amount of electric current flows therebetween. Accordingly, in the first regions 1220A and 1230A, the amount of heat generated by the resistive heat generator 1210 is relatively large.

The second regions 1220B and 1230B are regions not facing each other with the resistive heat generator 1210 interposed therebetween in the thickness direction of the resistive heat generator 1210. In detail, the second regions 1220B and 1230B are partially-cut-out regions of the first metal plate 1220 and the second metal plate 1230 such as not to face each other with the resistive heat generator 1210 interposed therebetween in the thickness direction of the resistive heat generator 1210.

For example, the first metal plate 1220 and the second metal plate 1230 in the second regions 1220B and 1230B may be cut out such that edges located diagonally from each other in the cross-sectional shape (i.e., the rectangular shape) of the resistive heat generator 1210 in the thickness direction remain. For example, the first metal plate 1220 in the second region 1220B may have a rectangular region cut out therefrom such that a left edge thereof remains. The second metal plate 1230 in the second region 1230B may have a rectangular region cut out therefrom such that a right edge thereof remains.

In the second regions 1220B and 1230B, the distance between the first metal plate 1220 and the second metal plate 1230 is substantially equal to the length of a diagonal line of the cross-sectional shape (i.e., the rectangular shape) of the resistive heat generator 1210. Therefore, in the second regions 1220B and 1230B, the distance between the first metal plate 1220 and the second metal plate 1230 is relatively long, so that the electrical resistance value between the first metal plate 1220 and the second metal plate 1230 is increased, whereby electric current is less likely to flow therebetween. Accordingly, in the second regions 1220B and 1230B, the amount of heat generated by the resistive heat generator 1210 is relatively small.

Consequently, with regard to the first metal plate 1220 and the second metal plate 1230, the amount of heat generated by the resistive heat generator 1210 can be adjusted by adjusting the distances between the first regions 1220A and 1230A and the second regions 1220B and 1230B. In detail, with regard to the first metal plate 1220 and the second metal plate 1230, the amount of heat generated by the resistive heat generator 1210 in the first regions 1220A and 1230A at the leading end (i.e., the upper side) can be increased, and the amount of heat generated by the resistive heat generator 1210 in the second regions 1220B and 1230B at the trailing end (i.e., the lower side) can be reduced. In such a case, the heater body 1250 can heat the stick substrate 150 more efficiently.

The trailing ends of the first metal plate 1220 and the second metal plate 1230 may each have a length equal to that of the trailing end of the resistive heat generator 1210. In such a case, as illustrated in FIG. 3, the first metal plate 1220 and the second metal plate 1230 are bonded to the resistive heat generator 1210 at both the first regions 1220A and 1230A and the second regions 1220B and 1230B.

As mentioned above, in the second regions 1220B and 1230B, the first metal plate 1220 and the second metal plate 1230 have cut-out regions that are diagonal from each other, so as not to face each other with the resistive heat generator 1210 interposed therebetween in the thickness direction of the resistive heat generator 1210. Therefore, in the second regions 1220B and 1230B, the electrical resistance value between the first metal plate 1220 and the second metal plate 1230 is increased, whereby the amount of heat generated from the resistive heat generator 1210 decreases. Hence, in the second regions 1220B and 1230B, the effect on the surroundings caused by the heat generated from the resistive heat generator 1210 decreases. Consequently, the heater body 1250 is held by the securing section 1260 at the second regions 1220B and 1230B of the first metal plate 1220 and the second metal plate 1230, thereby suppressing transmission of the heat to the securing section 1260.

The securing section 1260 is a structural member that secures the heater body 1250 to the housing of the inhaler device 100. In detail, the securing section 1260 has a cylindrical or prismatic shape having an insertion section 1261 with a slit-like recess structure or through-hole structure.

The securing section 1260 may be composed of a super engineering plastic material. A super engineering plastic material has high heat resistance and high mechanical strength and can be formed into a desired shape inexpensively by injection molding, and is therefore suitable for use as a material for forming a structural member. For example, the securing section 1260 may be composed of PEEK (polyether ether ketone), which is a type of engineering plastic material. PEEK is thermoplastic resin having extremely high heat resistance and also having high dimensional stability. Therefore, with the securing section 1260 being composed of PEEK, a dimensional change caused by the heat generated by the resistive heat generator 1210 can be further reduced.

The insertion section 1261 may be one recess or through-hole into which the heater body 1250 is to be inserted. The first metal plate 1220 in the second region 1220B, the second metal plate 1230 in the second region 1230B, and the resistive heat generator 1210 may be inserted into the insertion section 1261 of the securing section 1260. In addition to the first metal plate 1220 and the second metal plate 1230, the resistive heat generator 1210 is inserted into the insertion section 1261 so that the securing section 1260 can hold the heater body 1250 more securely.

Since the amount of heat generated by the resistive heat generator 1210 in the second regions 1220B and 1230B is small, transmission of the heat to the securing section 1260 is reduced even when the resistive heat generator 1210 is held by the securing section 1260. Therefore, in the inhaler device 100 according to this embodiment, transmission of the heat generated by the resistive heat generator 1210 to areas other than the stick substrate 150 can be suppressed. Consequently, the inhaler device 100 according to this embodiment can enhance the heating efficiency of the stick substrate 150 and reduce an effect that the heat produced from the heater 121 has on the reliability.

### 3. Modifications

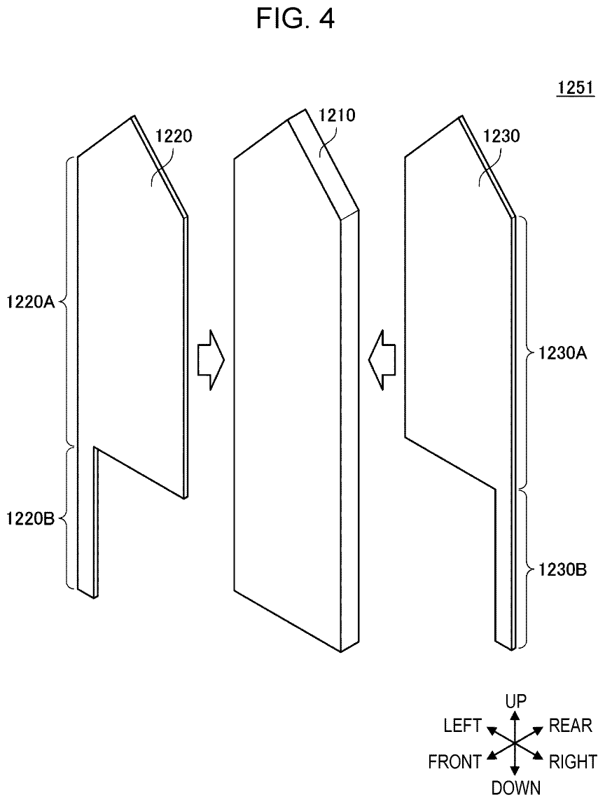

First to fourth modifications of the heater body 1250 according to this embodiment will now be described with reference to FIG. 4 to FIG. 7. Since the first metal plate 1220 and the second metal plate 1230 are interchangeable, a description about the first metal plate 1220 can be interchangeably interpreted as a description about the second metal plate 1230.

### (First Modification)

FIG. 4 is an exploded perspective view of a heater body 1251 according to a first modification. In FIG. 4, the up-down direction, the front-rear direction, and the left-right direction are defined similarly to FIG. 2 and FIG. 3. In detail, a direction in which the leading end of the heater body 1251 is inserted into the stick substrate 150 may also be referred to as “up direction”, and a direction opposite the up direction may also be referred to as “down direction”. A direction in which the first metal plate 1220, the resistive heat generator 1210, and the second metal plate 1230 are bonded together may also be referred to as “front-rear direction”, and a direction orthogonal to the up-down direction and the front-rear direction may also be referred to as “left-right direction”.

As illustrated in FIG. 4, in the heater body 1251 according to the first modification, the first regions 1220A and 1230A of the first metal plate 1220 and the second metal plate 1230 may have a shape that corresponds to the shape of the resistive heat generator 1210. In detail, similar to the resistive heat generator 1210, the first regions 1220A and 1230A of the first metal plate 1220 and the second metal plate 1230 may each have a pentagonal shape whose apex exists at the leading end to be inserted into the stick substrate 150. Accordingly, with regard to each of the first metal plate 1220 and the second metal plate 1230, the leading end thereof to be inserted into the stick substrate 150 has a pointy shape like a sword tip, so that the heater 121 can be inserted into the stick substrate 150 more readily.

### (Second Modification)

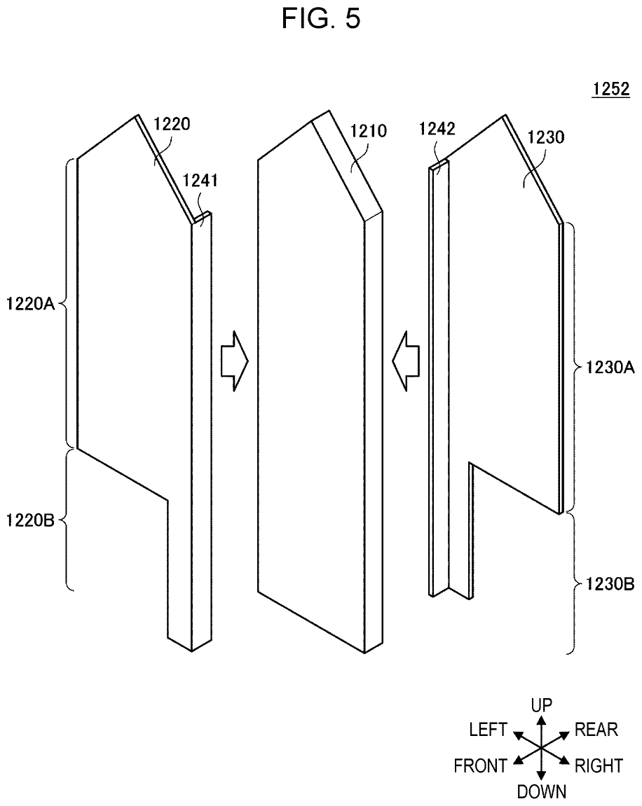

FIG. 5 is an exploded perspective view of a heater body 1252 according to a second modification. In FIG. 5, the up-down direction, the front-rear direction, and the left-right direction are defined similarly to FIG. 2 and FIG. 3. In detail, a direction in which the leading end of the heater body 1252 is inserted into the stick substrate 150 may also be referred to as “up direction”, and a direction opposite the up direction may also be referred to as “down direction”. A direction in which the first metal plate 1220, the resistive heat generator 1210, and the second metal plate 1230 are bonded together may also be referred to as “front-rear direction”, and a direction orthogonal to the up-down direction and the front-rear direction may also be referred to as “left-right direction”.

As illustrated in FIG. 5, in the heater body 1252 according to the second modification, the first metal plate 1220 is provided with a first rib 1241, and the second metal plate 1230 is provided with a second rib 1242.

In detail, the first rib 1241 is formed by bending one of the edges, in the lateral direction (i.e., the left-right direction) of the long shape of the first metal plate 1220, along the outer shape of the resistive heat generator 1210. The second rib 1242 is formed by bending the other one of the edges, in the lateral direction (i.e., the left-right direction) of the long shape of the second metal plate 1230, along the outer shape of the resistive heat generator 1210.

In an example, as illustrated in FIG. 5, the first rib 1241 may be formed by bending the right edge in the first region 1220A and the second region 1220B of the first metal plate 1220. The second rib 1242 may be formed by bending the left edge in the first region 1230A and the second region 1230B of the second metal plate 1230.

In another example, although not illustrated, the first rib 1241 may be formed by bending only the left edge in the first region 1220A of the first metal plate 1220. The second rib 1242 may be formed by bending only the right edge in the first region 1230A of the second metal plate 1230.

With the first rib 1241 and the second rib 1242 provided, the first metal plate 1220 and the second metal plate 1230 have increased strength in the front-rear direction in which the first rib 1241 and the second rib 1242 are bent, so that deformation in the front-rear direction can be suppressed. Accordingly, the heater body 1252 is less likely to deform in the normal direction to the principal surfaces of the first metal plate 1220 and the second metal plate 1230, so that the possibility of breakage of the heater 121 in the normal direction can be reduced.

### (Third Modification)

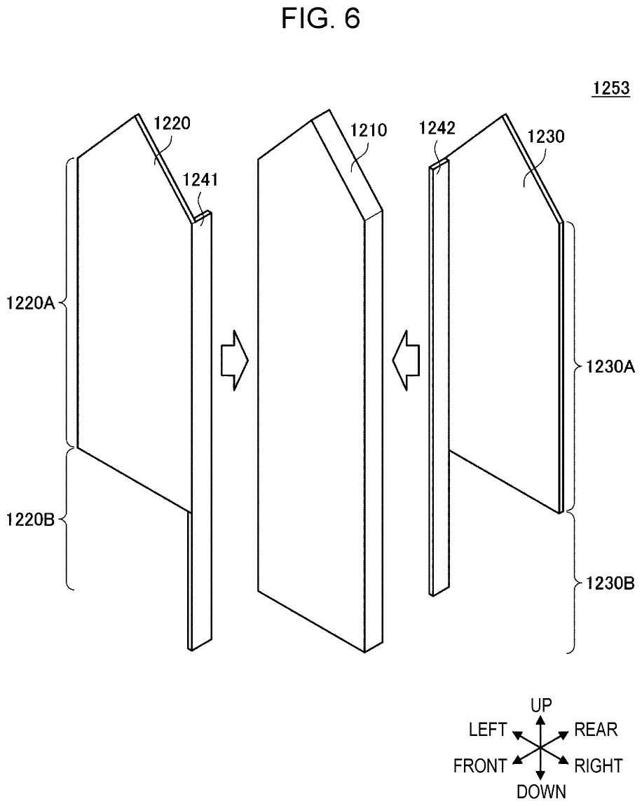

FIG. 6 is an exploded perspective view of a heater body 1253 according to a third modification. In FIG. 6, the up-down direction, the front-rear direction, and the left-right direction are defined similarly to FIG. 2 and FIG. 3. In detail, a direction in which the leading end of the heater body 1253 is inserted into the stick substrate 150 may also be referred to as “up direction”, and a direction opposite the up direction may also be referred to as “down direction”. A direction in which the first metal plate 1220, the resistive heat generator 1210, and the second metal plate 1230 are bonded together may also be referred to as “front-rear direction”, and a direction orthogonal to the up-down direction and the front-rear direction may also be referred to as “left-right direction”.

As illustrated in FIG. 6, in the heater body 1253 according to the third modification, the first metal plate 1220 is provided with the first rib 1241, and the second metal plate 1230 is provided with the second rib 1242. In the second regions 1220B and 1230B, the surfaces of the first metal plate 1220 and the second metal plate 1230 facing each other in the thickness direction of the resistive heat generator 1210 are entirely cut out. Accordingly, the second regions 1220B and 1230B of the first metal plate 1220 and the second metal plate 1230 are only provided with the first rib 1241 and the second rib 1242.

Specifically, in the heater body 1253 according to the third modification, the surfaces of the first metal plate 1220 and the second metal plate 1230 in the second regions 1220B and 1230B may be entirely cut out without having any edges remaining.

Accordingly, the resistive heat generator 1210 is supplied with electricity between the first rib 1241 and the second rib 1242. In such a case, the distance between the first rib 1241 and the second rib 1242 becomes the width of the resistive heat generator 1210 in the left-right direction. Therefore, the electrical resistance value between the first rib 1241 and the second rib 1242 is higher than the electrical resistance value between the first metal plate 1220 and the second metal plate 1230 in the first regions 1220A and 1230a. Hence, the heater body 1253 according to the third modification can reduce the amount of heat generated by the resistive heat generator 1210 in the second regions 1220B and 1230B relative to the amount of heat generated by the resistive heat generator 1210 in the first regions 1220A and 1230A. Specifically, the heater body 1253 according to the third modification is similar to the heater body 1250 illustrated in FIG. 2 and FIG. 3 in being able to enhance the heating efficiency of the stick substrate 150 and to reduce an effect that the heat produced from the heater 121 has on the reliability.

### (Fourth Modification)

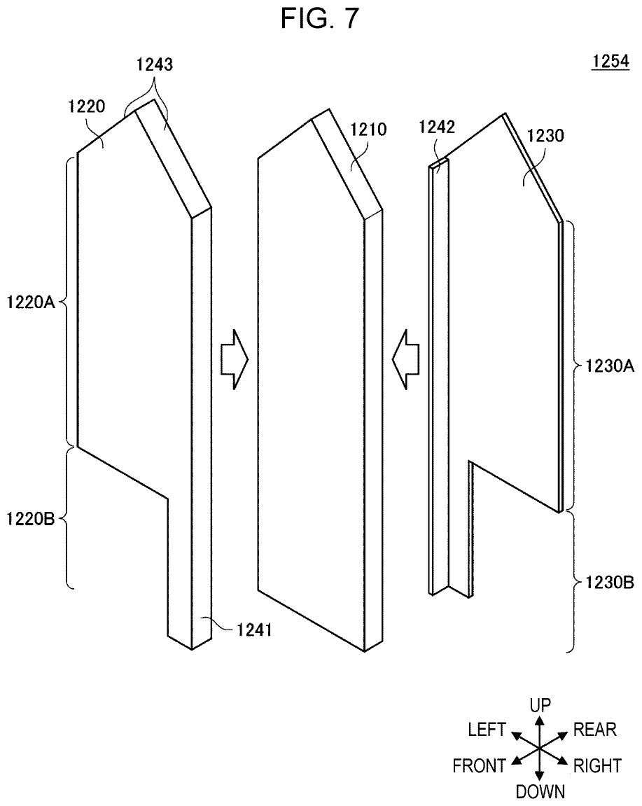

FIG. 7 is an exploded perspective view of a heater body 1254 according to a fourth modification. In FIG. 7, the up-down direction, the front-rear direction, and the left-right direction are defined similarly to FIG. 2 and FIG. 3. In detail, a direction in which the leading end of the heater body 1254 is inserted into the stick substrate 150 may also be referred to as “up direction”, and a direction opposite the up direction may also be referred to as “down direction”. A direction in which the first metal plate 1220, the resistive heat generator 1210, and the second metal plate 1230 are bonded together may also be referred to as “front-rear direction”, and a direction orthogonal to the up-down direction and the front-rear direction may also be referred to as “left-right direction”.

As illustrated in FIG. 7, the heater body 1254 according to the fourth modification is provided with the first rib 1241 and the second rib 1242 described in the second modification. Moreover, leading-end ribs 1243 are further provided in conformity with the angularly protruding shape toward the leading end (i.e., in the up direction) of the resistive heat generator 1210.

In detail, the leading-end ribs 1243 are formed by bending upper edges (located toward the leading end of the resistive heat generator 1210) of the first metal plate 1220 or the second metal plate 1230 along the outer shape of the resistive heat generator 1210. For example, the leading-end ribs 1243 may be formed by bending two upper edges of the first metal plate 1220 or the second metal plate 1230 in conformity with the angularly protruding shape toward the leading end of the resistive heat generator 1210.

With the leading-end ribs 1243 provided, the first metal plate 1220 and the second metal plate 1230 can cover the sword-tip-like pointy-shaped leading end (i.e., the upper end) of the resistive heat generator 1210. Accordingly, when the heater 121 is inserted into the stick substrate 150, the heater body 1254 can prevent delamination of the first metal plate 1220 and the second metal plate 1230 from the resistive heat generator 1210. Therefore, the heater body 1254 can further improve the durability of the heater 121 against insertion thereof into the stick substrate 150.

Although a preferred embodiment of the present invention has been described in detail above with reference to the appended drawings, the present invention is not limited to this example. It is apparent to a person with a common knowledge of the technical field to which the present invention belongs that various modifications and alterations are conceivable within the scope of the technical ideas defined in the claims, and it is to be understood that such modifications and alterations naturally belong to the technical scope of the present invention.

The following configurations also belong to the technical scope of the present invention.

(1) An aerosol generation system comprising:
a resistive heat generator that heats an aerosol generating substrate from an inside thereof; and
a pair of metal plates provided at opposite surfaces of the resistive heat generator,
wherein the pair of metal plates each include a first region and a second region, the first region being where the metal plates face each other with the resistive heat generator interposed therebetween in a thickness direction of the resistive heat generator, the second region being where the metal plates do not face each other with the resistive heat generator interposed therebetween in the thickness direction of the resistive heat generator.

(2) The aerosol generation system according to (1), wherein the first regions are provided toward a leading end of the resistive heat generator to be inserted into the aerosol generating substrate, and the second regions are provided toward a trailing end opposite the leading end.

(3) The aerosol generation system according to (1) or (2), wherein the second regions are provided as partial cut-outs of the metal plates such that the metal plates do not face each other with the resistive heat generator interposed therebetween in the thickness direction of the resistive heat generator.

(4) The aerosol generation system according to (3), wherein the pair of metal plates in the second regions are partially cut out such that edges of the metal plates remain, the edges being located diagonally from each other in a cross-sectional shape of the resistive heat generator.

(5) The aerosol generation system according to (4), wherein the metal plates cut out in the second regions have a rectangular shape.

(6) The aerosol generation system according to any one of (1) to (5), further comprising a securing section having an insertion section into which the metal plates and the resistive heat generator are inserted, the securing section securing the metal plates and the resistive heat generator to a housing.

(7) The aerosol generation system according to (6), wherein the metal plates in the second regions and the resistive heat generator are inserted into the insertion section.

(8) The aerosol generation system according to (6) or (7), wherein the securing section is composed of a super engineering plastic material. (9) The aerosol generation system according to any one of (6) to (8), wherein the securing section has a circular or rectangular tabular shape.

(10) The aerosol generation system according to (9), wherein each of the metal plates is composed of a nickel-containing iron alloy.

(11) The aerosol generation system according to any one of (1) to (10), wherein the resistive heat generator has a tabular shape.

(12) The aerosol generation system according to (11), wherein a thickness of the tabular shape is smaller than ¼ of a width of the tabular shape.

(13) The aerosol generation system according to any one of (1) to (12), further comprising the aerosol generating substrate into which the resistive heat generator and the metal plates are inserted.

(14) The aerosol generation system according to any one of (1) to (13), wherein at least one of the metal plates includes a rib formed by bending an edge of the metal plate along an outer shape of the resistive heat generator from the opposite surfaces of the resistive heat generator.

(15) The aerosol generation system according to any one of (1) to (14), wherein the resistive heat generator has an angularly protruding shape toward a leading end to be inserted into the aerosol generating substrate.

(16) The aerosol generation system according to (15), wherein at least one of the metal plates further includes a leading-end rib formed by bending an edge of the metal plate along the shape at the leading end of the resistive heat generator.

(17) The aerosol generation system according to any one of (1) to (16), wherein the resistive heat generator and the metal plates are adhered together by using a conductive adhesive paste.

(18) The aerosol generation system according to any one of (1) to (17), wherein the resistive heat generator is a PTC heater.

(19) The aerosol generation system according to (18), wherein the resistive heat generator contains barium titanate.

(20) The aerosol generation system according to any one of (1) to (19), wherein a temperature of heat generated by the resistive heat generator is below 350° C.

### REFERENCE SIGNS LIST

100 inhaler device
121 heater
140 container
141 internal space
142 opening
143 bottom
150 stick substrate
151 substrate
152 inhalation port
1210 resistive heat generator
1220 first metal plate
1220A, 1230A first region
1220B, 1230B second region
1230 second metal plate
1240 rib
1241 first rib
1242 second rib
1243 leading-end rib
1250, 1251, 1252, 1253, 1254 heater body
1260 securing section
1261 insertion section

1. An aerosol generation system comprising:
a resistive heat generator that heats an aerosol generating substrate from an inside thereof; and
a pair of metal plates provided at opposite surfaces of the resistive heat generator,
wherein the pair of metal plates each include a first region and a second region, the first region being where the metal plates face each other with the resistive heat generator interposed therebetween in a thickness direction of the resistive heat generator, the second region being where the metal plates do not face each other with the resistive heat generator interposed therebetween in the thickness direction of the resistive heat generator.

2. The aerosol generation system according to claim 1, wherein the first regions are provided toward a leading end of the resistive heat generator to be inserted into the aerosol generating substrate, and the second regions are provided toward a trailing end opposite the leading end.

3. The aerosol generation system according to claim 1, wherein the second regions are provided as partial cut-outs of the metal plates such that the metal plates do not face each other with the resistive heat generator interposed therebetween in the thickness direction of the resistive heat generator.

4. The aerosol generation system according to claim 3, wherein the pair of metal plates in the second regions are partially cut out such that edges of the metal plates remain, the edges being located diagonally from each other in a cross-sectional shape of the resistive heat generator.

5. The aerosol generation system according to claim 4, wherein the metal plates cut out in the second regions have a rectangular shape.

6. The aerosol generation system according to claim 1, further comprising a securing section having an insertion section into which the metal plates and the resistive heat generator are inserted, the securing section securing the metal plates and the resistive heat generator to a housing.

7. The aerosol generation system according to claim 6, wherein the metal plates in the second regions and the resistive heat generator are inserted into the insertion section.

8. The aerosol generation system according to claim 6, wherein the securing section is composed of a super engineering plastic material.

9. The aerosol generation system according to claim 6, wherein the securing section has a circular or rectangular tabular shape.

10. The aerosol generation system according to claim 9, wherein each of the metal plates is composed of a nickel-containing iron alloy.

11. The aerosol generation system according to claim 1, wherein the resistive heat generator has a tabular shape.

12. The aerosol generation system according to claim 11, wherein a thickness of the tabular shape is smaller than ¼ of a width of the tabular shape.

13. The aerosol generation system according to claim 1, further comprising the aerosol generating substrate into which the resistive heat generator and the metal plates are inserted.

14. The aerosol generation system according to claim 1, wherein at least one of the metal plates includes a rib formed by bending an edge of the metal plate along an outer shape of the resistive heat generator from the opposite surfaces of the resistive heat generator.

15. The aerosol generation system according to claim 1, wherein the resistive heat generator has an angularly protruding shape toward a leading end to be inserted into the aerosol generating substrate.

16. The aerosol generation system according to claim 15, wherein at least one of the metal plates further includes a leading-end rib formed by bending an edge of the metal plate along the shape at the leading end of the resistive heat generator.

17. The aerosol generation system according to claim 1, wherein the resistive heat generator and the metal plates are adhered together by using a conductive adhesive paste.

18. The aerosol generation system according to claim 1, wherein the resistive heat generator is a PTC heater.

19. The aerosol generation system according to claim 18, wherein the resistive heat generator contains barium titanate.

20. The aerosol generation system according to claim 1, wherein a temperature of heat generated by the resistive heat generator is below 350° C.
